(19) United States
(12) Patent Application Publication
(10) Pub. No.: US 2017/0190225 A1
(43) Pub. Date: Jul. 6, 2017

(54) TIRE PRESSURE MONITORING SYSTEM AND ITS APPLICATION METHOD

(71) Applicant: CUB ELECPARTS INC., CHANGHUA COUNTY (TW)

(72) Inventors: San-Chuan YU, CHANGHUA COUNTY (TW); Tsan-Nung WANG, CHANGHUA COUNTY (TW); Ya-Ling CHI, TAICHUNG CITY (CN); Jyong LIN, CHANGHUA COUNTY (TW); Ming-Hung LIN, YUANLIN CITY (TW); Hsiao-Ming CHEN, CHANGHUA COUNTY (TW); Wei-Hung MA, CHANGHUA COUNTY (TW)

(21) Appl. No.: 14/989,380

(22) Filed: Jan. 6, 2016

(51) Int. Cl. B60C 23/04

(52) U.S. Cl. CPC B60C 23/0447; B60C 23/0435; B60C 23/0483; B60C 23/0479

(57) ABSTRACT

A tire pressure monitoring system includes a main unit carried in a motor vehicle having one or multiple vehicle tires, and a tire pressure sensor installed in each vehicle tire of the motor vehicle and electrically connected to the main unit through a wireless communication SoC (system-on-chip) therein in a wireless manner. The wireless communication SoC of each tire pressure sensor includes a first communication protocol and a second communication protocol the related data of the respective vehicle tire. Thus, the tire pressure monitoring system improves data signal transmission efficiency and achieves dual-mode transmission.

### BACKGROUND OF THE INVENTION

1. Field of the Invention

The present invention relates to tire pressure monitoring technology and more particularly, to a tire pressure monitoring system, which transmits tire pressure and other related data of at least one vehicle tire of a motor vehicle carrying the system according to a first communication protocol and a second communication protocol.

2. Description of the Related Art

At the present time, in order to enhance driving safety, motor vehicles are commonly equipped with a tire pressure monitoring system (TPMS) and related devices for displaying the tire pressure, temperature and other related data of each vehicle tire measured by the respective tire pressure sensor by means of an analog or electronic display device.

Commercially available tire pressure monitoring systems commonly work at 433 MHz and 315 MHz, and adapted for transmitting data by Amplitude Shift Keying (ASK) and Frequency Shift Keying (FSK). The ASK technique is relatively simple, however, it has poor anti-noise capability. The FSK technique has the disadvantages that the rate of frequency changes is limited by the bandwidth of the line, and that distortion caused by the lines makes the detection even harder than amplitude modulation.

The aforesaid data transmission methods are based on Manchester Encoding that needs to occupy the transmission channel for a predetermined period of time before transmitting a data packet. Due to long transmission time of each data packet, collision and loss of data signals can occur during transmission. If the tire pressure, temperature and other related data of each vehicle tire cannot be provided to the main unit for letting the driver know at the first time during driving, it will lead to unpredictable consequences and serious accidents. Therefore, an improvement in this regard is necessary.

### SUMMARY OF THE INVENTION

The present invention has been accomplished under the circumstances in view. It is the main object of the present invention to provide a tire pressure monitoring system, which enables each tire pressure sensor thereof to transmit measured wireless data signals to a main unit or a smart electronic device according to a first communication protocol and a second communication protocol, thereby improving the data transmission efficiency and achieving dual-mode transmission.

To achieve this and other objects of the present invention, a tire pressure monitoring system comprises a main unit carried in a motor vehicle having at least one vehicle tire, and at least one tire pressure sensor installed in the at least one vehicle tire of the motor vehicle respectively. The main unit comprises a first microprocessor, a first communication module and a display unit. The first communication module and the display unit are respectively electrically connected to the first microprocessor. Each tire pressure sensor is electrically connected to the main unit in a wireless manner by a wireless communication SoC (system-on-chip) thereof. The data of each vehicle tire measured by the respective tire pressure sensor is sent out in a wireless manner by the respective wireless communication SoC (system-on-chip), and then received by the first communication module of the main unit for converting and processing by the first microprocessor. The converted and processed data is then displayed on the display unit by the first microprocessor. Further, the wireless communication SoC (system-on-chip) of each tire pressure sensor is capable of transmitting wireless data signals according to a first communication protocol and a second communication protocol. The first communication module of the main unit is capable of receiving wireless data signals from the wireless communication SoC (system-on-chip) of each tire pressure sensor according to the first communication protocol.

Preferably, the main unit further comprises a second communication module electrically connected to the first microprocessor. The second communication module of the main unit is configured to receive wireless data signal from the wireless communication SoC (system-on-chip) of each tire pressure sensor according to the second communication protocol.

Preferably, the tire pressure monitoring system further comprises relay unit. The relay unit comprises a third communication module and a fourth communication module. The third communication module is adapted for transmitting the data of each tire pressure sensor measured by the wireless communication SoC (system-on-chip) of the respective tire pressure sensor in a wireless manner according to the first communication protocol. The fourth communication module is adapted for transmitting the data of each tire pressure sensor measured by the wireless communication SoC (system-on-chip) of the respective tire pressure sensor in a wireless manner according to the second communication protocol.

Preferably, the relay unit further comprises a second microprocessor electrically connected with the third communication module and the fourth communication module respectively. The second microprocessor of the relay unit is electrically connected to the first communication module of the first microprocessor of the main unit in a wireless manner by the third communication module. The second microprocessor of the relay unit is electrically connected to the second communication module of the first microprocessor of the main unit in a wireless manner by the fourth communication module.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an applied view of a tire pressure monitoring system in accordance with the present invention.

FIG. 2 is a system architecture diagram of a tire pressure monitoring system in accordance with a first embodiment of the present invention.

FIG. 3 is a system architecture diagram of a tire pressure monitoring system in accordance with a second embodiment of the present invention.

FIG. 4 is a system architecture diagram of a tire pressure monitoring system in accordance with a third embodiment of the present invention.

FIG. 5 is an operational flow chart of the present invention.

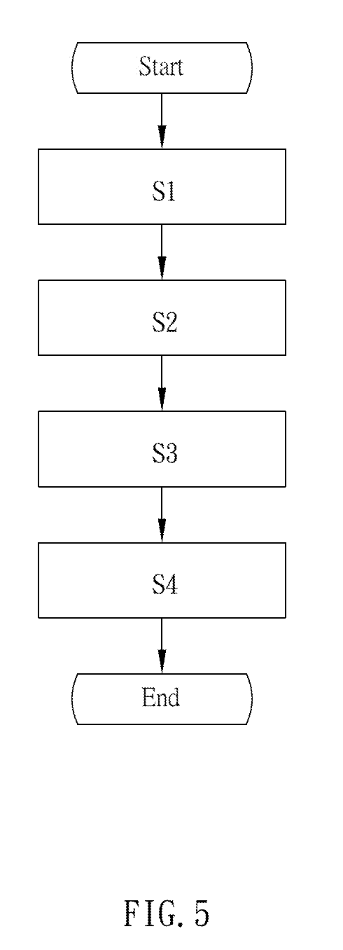

### DETAILED DESCRIPTION OF THE INVENTION

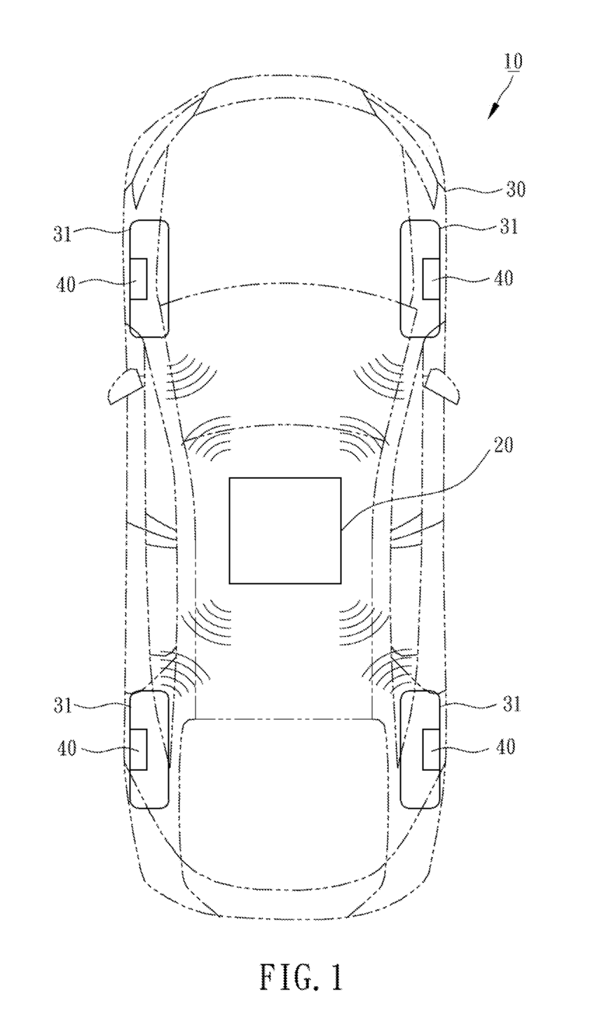

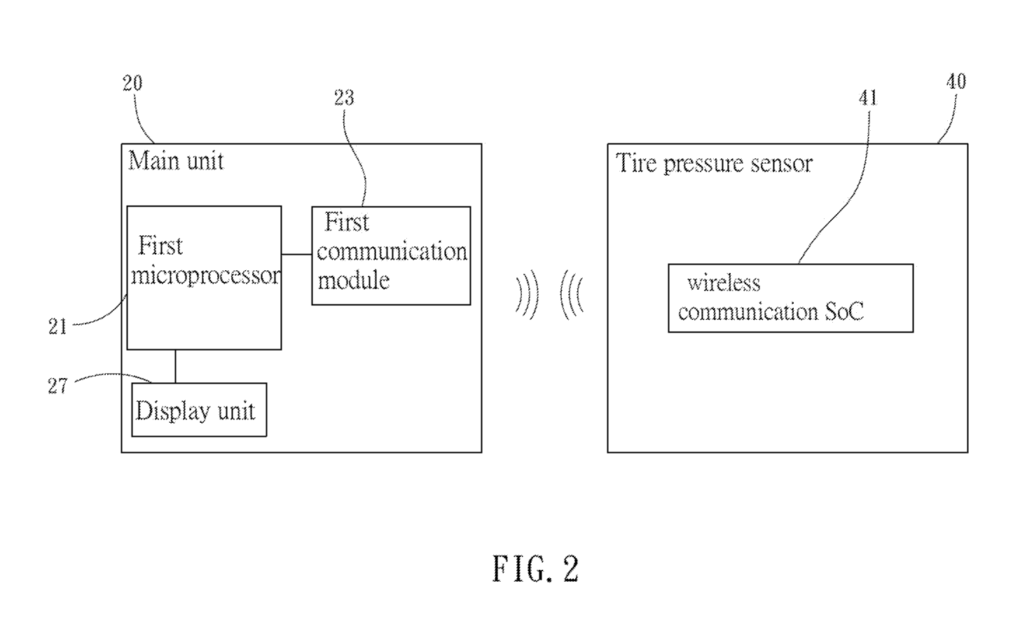

Referring to FIGS. 1 and 2, a tire pressure monitoring system in accordance with a first embodiment of the present invention is shown. The tire pressure monitoring system 10 comprises a main unit 20 and at least one tire pressure sensor 40.

The main unit 20 is mounted in a motor vehicle 30. The motor vehicle 30 comprises at least one vehicle tire 31. In this first embodiment, the motor vehicle 30 comprises four said vehicle tires 31.

Further, the main unit 20 comprises a first microprocessor 21, a first communication module 23 and a display unit 27. The first microprocessor 21 is respective electrically connected with the first communication module 23 and the display unit 27. The first communication module 23 of the main unit 20 is adapted for transmitting and receiving data according to a first communication protocol. In this first embodiment, the first communication protocol is a Bluetooth communication protocol, containing, but not limited to, Bluetooth h2.x+EDR,Bluetooth h3.0+HS,Bluetooth 4.x,Bluetooth Low Energy.

The at least one tire pressure sensor 40 is mounted in the at least one vehicle tire 31 of the motor vehicle 30, and electrically connected to the main unit 20 through a wireless communication SoC (system-on-chip) 41 thereof for measuring the tire pressure, temperature and other related data of the vehicle tire 31 instantly before or during driving. The wireless communication SoC (system-on-chip) 41 of the at least one tire pressure sensor 40 is capable of transmitting the related data of the at least one vehicle tire 31 according to a first communication protocol and a second communication protocol. The first communication protocol is a Bluetooth communication protocol, containing, but not limited to, Bluetooth h2.x+EDR, Bluetooth h3.0+HS, Bluetooth 4.x, Bluetooth Low Energy. The second communication protocol is a 2.4 Ghz wireless protocol. Preferably, the second communication protocol has the capability of ID matching and encryption for transmission of data signal at 2.4 Ghz.

Thus, the operating characteristics and effects of this first embodiment are outlined hereinafter. During operation, the tire pressure monitoring system measures the related data of the at least one vehicle tire 31 by means of the at least one tire pressure sensor 40, and then the measured data is sent out wirelessly by the wireless communication SoC (system-on-chip) 41 according to the first communication protocol, and the transmitted data is then received by the first communication module 23 of the main unit 20, and then provided by the first communication module 23 to the first microprocessor 21 for converting and processing enabling the processed data relative to the at least one vehicle tire 31 to be displayed by the first microprocessor 21 on the display unit 27. Alternatively, the related data of the at least one vehicle tire 31 can be sent out wirelessly by the wireless communication SoC (system-on-chip) 41 according to the second communication protocol, enabling the transmitted wireless data signal to be received by a wireless communication module of a smart electronic device, such as, but not limited to, smart phone, tablet computer, notebook computer, etc. (not shown). The data signal containing the related data of the at least one vehicle tire 31 is then converted and processed by a microprocessor (not shown) of the smart electronic device, and then displayed on a display screen of a display module (not shown) of the smart electronic device. In this first embodiment, the motor vehicle 30 comprises four said vehicle tires 31, each vehicle tire 31 carrying one said tire pressure sensor 40 that is electrically connected to the main unit 20 wirelessly by the wireless communication SoC (system-on-chip) 41 thereof.

When compared to the prior art techniques, this first embodiment of the present invention has the features as follows:

First, the system of the present invention is capable of sending out the tire pressure, temperature and other related data of each vehicle tire 31 instantly measured by the respective tire pressure sensor 40 by means of the respective wireless communication SoC (system-on-chip) 41 thereof in a wireless manner, and then received by the first communication module 23 of the main unit 20 for converting and processing by the first microprocessor 21 so that the converted and processed data related to the at least one vehicle tire 31 can then be displayed on the display unit 27, eliminating the problem of the prior art technique that needs to use an operating system to activate the wireless communication unit of the tire pressure sensor 40 for communication establishment, i.e., the wireless communication SoC (system-on-chip) 41 of the tire pressure sensor 40 is enabled to transmit signal in a wireless manner for establishing Bluetooth communication with the first communication module 23 of the main unit 20 according to the first communication protocol.

Second, the data packet transmission speed of conventional Amplitude Shift Keying (ASK) is about 4200 bps, and the data packet transmission speed of conventional Frequency Shift Keying (FSK) is about 9600 bps. Thus, if the data length of the data packet of the tire pressure, temperature and other related data of one vehicle tire 31 measured by the respective tire pressure sensor 40 is 13 bytes, it can be seen that the transmission of the 13 bytes data packet it will take about (13 byte)×(8 bits)×(1/4200)≈0.0248 (sec) when through Amplitude Shift Keying (ASK), or about (13 byte)×(8 bits)×(1/9600)≈0.0108 (sec) when through Frequency Shift Keying (FSK). Preferably, if the first communication protocol has the function of Bluetooth low energy 4.0, it takes only about (13 byte)×(8 bits)×(1/1000000)≈0.000104 (sec) for the transmission of the 13 bytes data packet, or about 238 times more efficient in transmission speed when compared with Amplitude Shift Keying (ASK), or 104 times more efficient in speed when compared with Frequency Shift Keying (FSK). Thus, the invention greatly improves data packet transmission efficiency.

After understanding of the operating characteristics and effects of the first embodiment of the present invention, the operating characteristics and effects of a second embodiment of the present invention are described hereinafter.

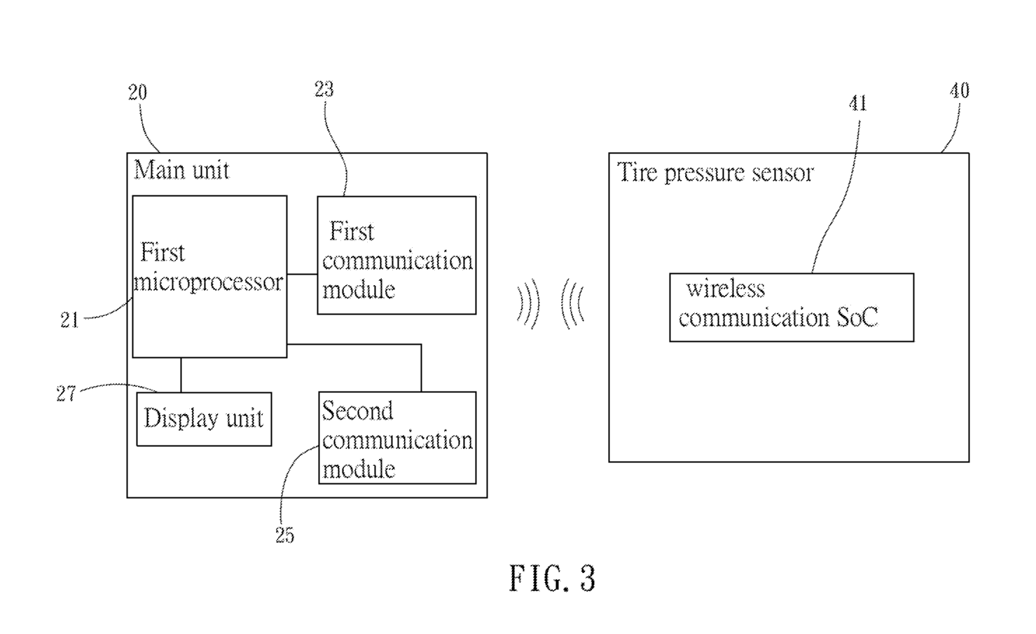

Referring to FIG. 3, a tire pressure monitoring system 10 in accordance with the second embodiment of the present invention is shown. The tire pressure monitoring system 10 is substantially similar to the aforesaid first embodiment with the differences as stated below.

The main unit 20 further comprises a second communication module 25 electrically connected to the first microprocessor 21. The second communication module 25 of the main unit 20 is capable of transmitting and received wireless data signals according to the second communication protocol. Preferably, the second communication protocol has the capability of ID matching and encryption for transmission of data signal at 2.4 Ghz.

Thus, this second embodiment of the present invention has the operating characteristics and effects: The data of the at least one vehicle tire 31 measured by the at least one tire pressure sensor 40 is sent out wirelessly by the wireless communication SoC (system-on-chip) 41 according to the first communication protocol, and then received by the first communication module 23 of the main unit 20, or alternatively, the data of the at least one vehicle tire 31 measured by the at least one tire pressure sensor 40 can be sent out wirelessly by the wireless communication SoC (system-on-chip) 41 according to the second communication protocol, and then received by the second communication module 25 of the main unit 20, and then, the received data related to the at least one vehicle tire 31 is converted and processed by the first microprocessor 21 and then displayed on the display unit 27.

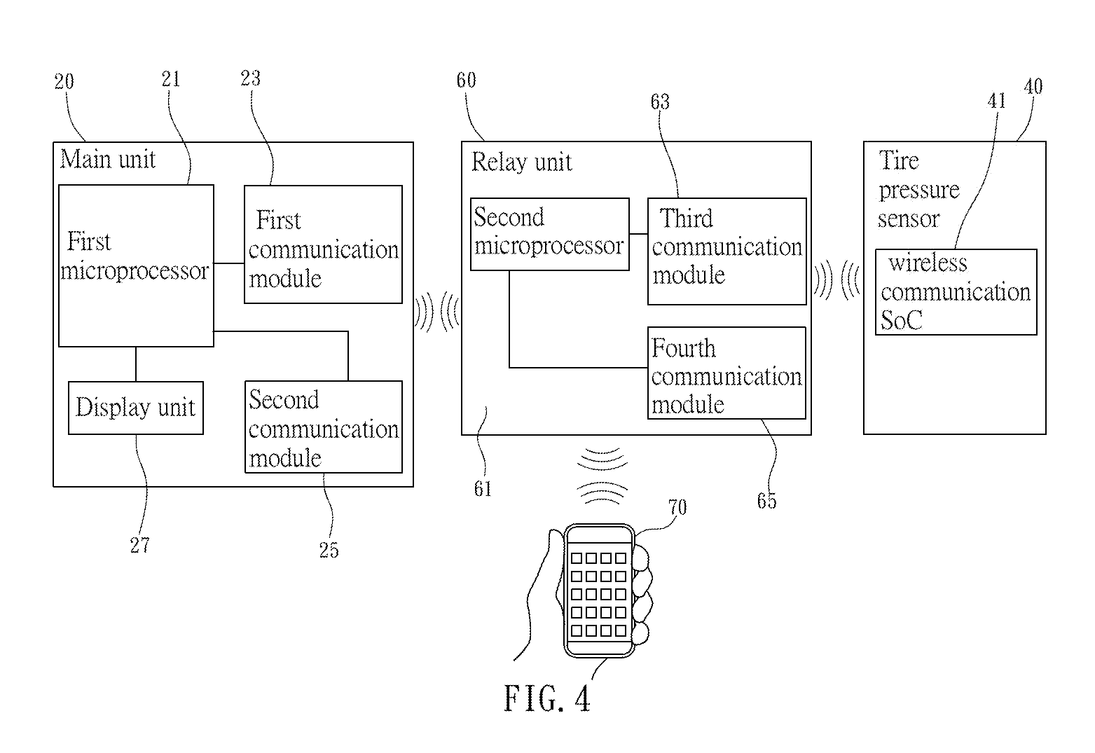

Referring also to FIG. 4, a tire pressure monitoring system 50 in accordance with a third embodiment of the present invention is shown. The tire pressure monitoring system 50 of this third embodiment is substantially similar to the aforesaid first and second embodiments with the exceptions as outlined hereinafter.

The tire pressure monitoring system 50 further comprises a relay unit 60. The relay unit 60 comprises a second microprocessor 61, a third communication module 63 and a fourth communication module 65. The second microprocessor 61 is respective electrically connected with the third communication module 63 and the fourth communication module 65 respectively. The third communication module 63 of the relay unit 60 is adapted for receiving and transmitting wireless data signals been provided by the wireless communication SoC (system-on-chip) 41 of the at least one tire pressure sensor 40 according to the first communication protocol. Further, the fourth communication module 65 of the relay unit 60 is adapted for receiving and transmitting wireless data signals been provided by the wireless communication SoC (system-on-chip) 41 of the at least one tire pressure sensor 40 according to the second communication protocol.

The second microprocessor 61 of the relay unit 60 is wireless electrically connected to the first microprocessor 21 and first communication module 23 of the main unit 20 and also electrically connected to a communication module (not shown) of a smart electronic device 70 (such as, but not limited to, smart phone, tablet computer, notebook computer, etc.) in a wireless manner through the third communication module 63.

The second microprocessor 61 of the relay unit 60 is wireless electrically connected to the first microprocessor 21 and second communication module 25 of the main unit 20 and also electrically connected to a communication module (not shown) of a smart electronic device 70 (such as, but not limited to, smart phone, tablet computer, notebook computer, etc.) in a wireless manner through the fourth communication module 65.

Thus, this third embodiment of the present invention has the operating characteristics and effects: When the tire pressure monitoring system is used in a trailer, van, truck or public transport vehicle that is equipped with multiple vehicle tires and has a relatively longer vehicle body, the tire pressure, temperature and other related data of each vehicle tire 31 measured by the respective tire pressure sensor 40 is sent out in a wireless manner by the wireless communication SoC (system-on-chip) 41 of the respective tire pressure sensor 40. In order to avoid signal attenuation during transmission due to unexpected reasons, the third communication module 63 of the relay unit 60 receives and retransmits data signals according to the first communication protocol that is a Bluetooth communication protocol. The wireless communication SoC (system-on-chip) 41 of each tire pressure sensor 40 transmits the data signal to the first communication module 23 of the main unit 20 or the wireless communication module of the smart electronic device 70 in a wireless manner. Or, the fourth communication module 65 of the relay unit 60 receives and retransmits the data signal according to the second communication protocol. The wireless data signal is transmitted by the wireless communication SoC (system-on-chip) 41 of each tire pressure sensor 40 to the second communication module 25 of the main unit 20 or the communication module of the smart electronic device 70. Thereafter, in the same manner, the first microprocessor 21 of the main unit 20 processes (demodulates) the received data of each vehicle tire 31 for display on the display unit 27, or, the microprocessor of the smart electronic device 70 the received data of each vehicle tire 31 for display on the display unit of the smart electronic device 70.

After understanding of the operating characteristics of effects of the third embodiment of the present invention, a tire pressure monitoring system application method 80 in accordance with the present invention is outlined hereinafter. The method includes the steps:

Step S1: Provide a main unit 20, and then mount the main unit 20 in a motor vehicle 30. The main unit 20 comprises a first microprocessor 21, a first communication module 23, a second communication module 25 and a display unit 27. The first microprocessor 21 is electrically connected with the first communication module 23, the second communication module 25 and the display unit 27 respectively. The first communication module 23 of the main unit 20 is capable of transmitting and receiving data signals according to a first communication protocol that is a Bluetooth communication protocol. The second communication module 25 of the main unit 20 is capable of transmitting and receiving data signals according to a second communication protocol that is a 2.4 Ghz communication protocol.

Step S2: Provide at least one tire pressure sensor 40, and then respectively install the at least one tire pressure sensor 40 in at least one vehicle tire 31 of the motor vehicle 30. Each tire pressure sensor 40 is electrically connected to the main unit 20 by a wireless communication SoC (system-on-chip) 41 thereof, and adapted for measuring the tire pressure, temperature and other related data of the respective vehicle tire 31 before or during driving, and then sending out the measured data in a wireless manner by the wireless communication SoC (system-on-chip) 41 thereof.

Step S3: At this time, the first communication module 23 of the main unit 20 receives the wireless dada signal that was sent out by the wireless communication SoC (system-on-chip) 41 according to the first communication protocol that is a Bluetooth communication protocol, or the second communication module 25 of the main unit 20 receives the wireless dada signal that was sent out by the wireless communication SoC (system-on-chip) 41 according to the second communication protocol that is a 2.4 Ghz communication protocol.

Step S4: At this time, the data signal containing the data of the at least one vehicle tire 31 and received by the firs communication module 23 or second communication module 25 of the main unit 20 is converted and processed by the first microprocessor 21 and then displayed on the display unit 27. In the Step S3, a relay unit 60 is provided. The relay unit 60 comprises a second microprocessor 61, a third communication module 63 and a fourth communication module 65. The second microprocessor 61 is electrically connected with third communication module 63 and the fourth communication module 65 respectively. The third communication module 63 of the relay unit 60 is adapted for receiving wireless data signals from the wireless communication SoC (system-on-chip) 41 of the at least one tire pressure sensor 40 and then retransmitting received wireless data signals to the first microprocessor 21 of the main unit 20 according to the first communication protocol. The fourth communication module 65 of the relay unit 60 is adapted for receiving wireless data signals from the wireless communication SoC (system-on-chip) 41 of the at least one tire pressure sensor 40 and then retransmitting received wireless data signals to the second communication module 25 of the main unit 20 according to the second communication protocol.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tire pressure monitoring system, comprising:
a main unit mounted in a motor vehicle, said motor vehicle comprising at least one vehicle tire, said main unit comprising a first microprocessor, a first communication module and a display unit, said first communication module and said display unit being respectively electrically connected to said first microprocessor; and
at least one tire pressure sensor installed in said at least one vehicle tire of said motor vehicle, said at least one tire pressure sensor being electrically connected to said main unit in a wireless manner through a wireless communication SoC (system-on-chip) thereof; the data of said at least one vehicle tire measured by the respective said at least one tire pressure sensor being transmitted to said first communication module of said main unit by said wireless communication SoC (system-on-chip) in a wireless manner and then received by said first communication module of said main unit, and then converted and processed by said first microprocessor for display on said display unit;
wherein said wireless communication SoC (system-on-chip) of each said tire pressure sensor is capable of transmitting the data of the respective said vehicle tire according to a first communication protocol and a second communication protocol; the first communication module of said main unit is capable of receiving wireless data signal transmitted by said wireless communication SoC (system-on-chip) of each said tire pressure sensor according to said first communication protocol.

2. The tire pressure monitoring system as claimed in claim 1, wherein said main unit further comprises a second communication module electrically connected to said first microprocessor, and adapted for receiving wireless data signal transmitted by said wireless communication SoC (system-on-chip) of each said tire pressure sensor according to said second communication protocol.

3. The tire pressure monitoring system as claimed in claim 2, further comprising a relay unit, said relay unit comprising a third communication module and a fourth communication module, said third communication module being configured for receiving wireless data signal transmitted by said wireless communication SoC (system-on-chip) of each said tire pressure sensor according to said first communication protocol, said fourth communication module being configured for receiving wireless data signal transmitted by said wireless communication SoC (system-on-chip) of each said tire pressure sensor according to said second communication protocol.

4. The tire pressure monitoring system as claimed in claim 3, wherein said relay unit further comprises a second microprocessor electrically connected with said third communication module and said fourth communication module respectively, said second microprocessor of said relay unit being wirelessly connected to said first communication module of said first microprocessor of said main unit through said third communication module, said second microprocessor of said relay unit being electrically connected to said second communication module of said first microprocessor of said main unit through said fourth communication module.

5. The tire pressure monitoring system as claimed in claims 4, wherein said first communication protocol is a Bluetooth communication protocol.

6. The tire pressure monitoring system as claimed in claims 1, wherein said first communication protocol is a Bluetooth communication protocol.

7. The tire pressure monitoring system as claimed in claims 2, wherein said first communication protocol is a Bluetooth communication protocol.

8. The tire pressure monitoring system as claimed in claims 3, wherein said first communication protocol is a Bluetooth communication protocol.

9. The tire pressure monitoring system as claimed in claim 1, wherein said second communication protocol is a 2.4 Ghz communication protocol.

10. The tire pressure monitoring system as claimed in claim 1, wherein said at least one tire pressure sensor and said at least one vehicle tire are multiple.

11. A tire pressure monitoring system application method, comprising the steps of:
Step S1: providing a main unit and mounting said main unit in a motor vehicle, said main unit comprising a first microprocessor, a first communication module, a second communication module and a display unit, said first microprocessor being electrically connected with said first communication module, said second communication module and said display unit respectively, said first communication module of said main unit being capable of transmitting and receiving data signals according to a first communication protocol, said second communication module of said main unit being capable of transmitting and receiving data signals according to a second communication protocol;
Step S2; providing at least one tire pressure sensor and mounting said at least one tire pressure sensor in at least one vehicle tire of a motor vehicle respectively, each said tire pressure sensor being electrically connected to said main unit by a wireless communication SoC (system-on-chip) thereof in a wireless manner, the data of said at least one vehicle tire measured by said at least one tire pressure sensor being sent out in a wireless manner by the respective said wireless communication SoC (system-on-chip);
Step S3: said first communication module of said main unit receiving said data of said at least one vehicle tire from said wireless communication SoC (system-on-chip) of each said tire pressure sensor in a wireless manner according to said first communication protocol, said second communication module of said main unit receiving said data of said at least one vehicle tire from said wireless communication SoC (system-on-chip) of each said tire pressure sensor in a wireless manner according to said second communication protocol; and
Step S4: said first microprocessor of said main unit converting and processing the data signal of said at least one vehicle tire been received by said first communication module and said second communication module, and then displaying the converted and processed data on said display unit.

12. The tire pressure monitoring system application method as claimed in claim 11, wherein said Step S3 further provides a relay unit comprising a second microprocessor, a third communication module and a fourth communication module, said second microprocessor being respectively electrically connected with said third communication module and said fourth communication module, said third communication module of said relay being adapted for receiving wireless data signals from said wireless communication SoC (system-on-chip) of each said tire pressure sensor and retransmitting the received wireless data signal to said first communication module of said first microprocessor of said main unit according to said first communication protocol, said fourth communication module of said relay unit being adapted for receiving wireless data signals from said wireless communication SoC (system-on-chip) of each said tire pressure sensor and retransmitting the received wireless data signal to said second communication module of said first microprocessor of said main unit according to said second communication protocol.

13. The tire pressure monitoring system application method as claimed in claim 12, wherein said first communication protocol is a Bluetooth communication protocol; said second communication protocol is a 2.4 Ghz communication protocol.
